(19) United States
(12) Patent Application Publication
(10) Pub. No.: US 2020/0161034 A1
(43) Pub. Date: May 21, 2020

(54) HIGH FREQUENCY MAGNETIC FILMS, METHOD OF MANUFACTURE, AND USES THEREOF

(71) Applicant: ROGERS CORPORATION, Chandler, AZ (US)

(72) Inventors: Yajie Chen, Brighton, MA (US); Xiaoyu Zhang, Suzhou City (CN); Li Zhang, Sichuan (CN); Yuanyuan Xing, Suzhou City (CN)

(21) Appl. No.: 16/676,736

(22) Filed: Nov. 7, 2019

Related U.S. Application Data
(60) Provisional application No. 62/767,553, filed on Nov. 15, 2018.

(51) Int. Cl. H01F 1/16; H01F 1/38; H01F 41/18; H01F 41/32

(52) U.S. Cl. CPC H01F 1/16; H01F 41/32; H01F 41/18; H01F 1/38

(57) ABSTRACT

A multilayer film includes a substrate; a first magnetic layer disposed on the substrate and a second magnetic layer disposed on the first magnetic layer. The first magnetic layer includes Fe₍₅₀₋₈₀₎N₍₁₀₋₂₀₎B₍₁₋₂₀₎M₍₀₋₁₀₎, wherein M is Si, Ta, Zr, Ti, Co, or a combination thereof. The second magnetic layer includes Fe₍₅₀₋₉₀₎N₍₁₀₋₅₀₎ or Fe₍₆₀₋₉₀₎N₍₁₋₁₀₎Ta₍₅₋₃₀₎. The multilayer magnetic film has, over a frequency range of 50 MHz to 10 GHz, a magnetic permeability of greater than or equal to 1800 over a selected frequency band in the frequency range; a magnetic loss tangent of less than or equal to 0.3 over a selected frequency band in the frequency range; and a cutoff frequency of greater than or equal to 1 GHz, or greater than or equal to 2 GHz.

### CROSS REFERENCE TO RELATED APPLICATION

This application claims the benefit of U.S. Provisional Patent Application Ser. No. 62/767,553 filed Nov. 15, 2018. The related application is incorporated herein in its entirety by reference.

### BACKGROUND

This disclosure relates generally to high frequency magnetic films, methods for their manufacture, and uses thereof, for example in integrated circuits, power supply systems, antennas, and the like.

Newer designs and manufacturing techniques have driven electronic components to increasingly smaller dimensions and higher frequencies. One approach to reducing electronic component size has been the use of magnetic materials. In particular, ferrites, ferroelectrics, and multiferroics have been widely studied as functional materials with enhanced microwave properties. While the high permeability of magnetic materials increases the DC value of inductance, it remains a challenge to extend that magnetic permeability and corresponding inductance enhancement to high frequencies (e.g., 1 to 5 gigahertz (GHz)), which are desired for various mobile applications. Magnetic permeability at these frequencies is sharply deteriorated due to Snoek's limit of the materials. At the intrinsic ferromagnetic resonance (FMR) frequency of magnetic materials (typically 1-2 GHz for large blanket films), the relative magnetic permeability drops to unity and the magnetic loss tangent peaks, such that the inductance enhancement due to the material is negligible and the losses are dominant It is possible to enhance the frequency response of magnetic permeability by varying methods of definition and patterning of the materials, but there still remains a need in the art for materials and methods that can provide high magnetic permeability and high resonance frequency over high bandwidths.

### BRIEF DESCRIPTION

Disclosed herein is a multi-layer magnetic film and a method of making the same.

In an embodiment, a multilayer film includes a substrate; a first magnetic layer disposed on the substrate and a second magnetic layer disposed on the first magnetic layer. The first magnetic layer includes Fe₍₅₀₋₈₀₎N₍₁₀₋₂₀₎B₍₁₋₂₀₎M₍₀₋₁₀₎, wherein M is Si, Ta, Zr, Ti, Co, or a combination thereof. The second magnetic layer includes Fe₍₅₀₋₈₀₎N₍₁₀₋₂₀₎B₍₁₋₂₀₎M₍₀₋₁₀₎.

The multilayer magnetic film has, over a frequency range of 50 megahertz (MHz) to 10 GHz, preferably over a frequency range of 100 MHz to 5 GHz, more preferably over a frequency range of 1 to 5 GHz, a magnetic permeability of greater than or equal to 1800, preferably greater than or equal to 2000, more preferably greater than or equal to 3000 to 5000 over a selected frequency band in the frequency range, preferably over a frequency band of 1 to 10 GHz; a magnetic loss tangent of less than or equal to 0.3, preferably less than or equal to 0.1, more preferably 0.01 to 0.1 over a selected frequency band in the frequency range, preferably over a frequency band of 1 to 10 GHz; and a cutoff frequency of greater than or equal to 1 GHz, or greater than or equal to 2 GHz, preferably greater than or equal to 5 GHz, or 1 to 8 GHz.

In an embodiment, a method of forming the multilayer film includes depositing the first magnetic layer onto a side of the substrate; and depositing the second magnetic layer onto a side of the first magnetic layer opposite to the substrate.

Articles includes the multi-layer magnetic films are further described. The article is preferably a filter, transformer, inductor, antenna, electronic integrated circuit chip, or electromagnetic shielding device.

The above and other features and advantages are readily apparent from the following detailed description, examples, and claims when taken in connection with the accompanying drawings.

### BRIEF DESCRIPTION OF THE DRAWINGS

Referring to the exemplary non-limiting figures wherein like elements are numbered alike:

FIG. 1 is a cross-sectional view of an embodiment of a multilayer magnetic film;

FIG. 2 is a cross-sectional view of another embodiment of a multilayer magnetic film;

FIG. 3 is a plot showing the high frequency characteristics of comparative Co- and Fe-based thin films and multilayers measured at room temperature;

FIG. 4 is a surface profile of an FeN film by profilometry and atomic force microscopy (AFM);

FIG. 5 is a magnetic hysteresis of FeN films along easy and hard magnetizing directions in a plane of the film;

FIG. 6 is a magnetic permeability spectrum of an FeN film with 60 nanometer (nm) thickness;

FIG. 7 is a surface profile of an FeN film by profilometry and AFM;

FIG. 8 is a magnetic permeability spectrum of an Fe₆₆N₁₈B₁₆ film with 50 nm thickness;

FIG. 9 shows the relationship between effective resistivity and magnetic permeability of an Fe₈₃₋ₓN₁₇Bₓ film with differing boron content;

FIG. 10 is magnetic spectra of Fe₇₄N₂₆/Fe₆₆N₁₈B₁₆ bi-layer films with various thicknesses of FeNB;

FIG. 11 is a magnetic permeability for Fe₇₄N₂₆/Fe₇₂N₁₈B₁₀ bi-layer films with different thicknesses of Fe₇₂N₁₈B₁₀;

FIG. 12 shows the relationship between effective resistivity and magnetic permeability of an Fe₈₂N₁₈/Fe₇₂N₁₈B₁₀/glass film with different thicknesses of an FeNB layer;

FIG. 13 is a magnetic hysterisis of an FeTaN film with thickness of 80 nm along x and y directions in a plane of the film;

FIG. 14 is a magnetic permeability spectrum of 80 nm-thick Fe₇₄Ta₆N₂₀ film on a glass substrate;

FIG. 15 is magnetic spectra for Fe₇₄Ta₆N₂₀/Fe₆₆N₁₈B₁₆ bi-layer films;

FIG. 16 shows the relationship between effective resistivity and magnetic permeability of an Fe₈₃Ta₆N₁₁/Fe₇₂N₁₈B₁₀/glass film with different thicknesses of an FeNB layer;

FIG. 17 is magnetic spectra for Fe₇₄Ta₆N₂₀/Fe₇₂N₁₈B₁₀ bi-layer films;

FIG. 18 shows the relationship between effective resistivity and total tri-layer film thickness of Fe₇₂N₁₈B₁₀/Fe₈₃N₁₁/Fe₇₂N₁₈B₁₀ tri-layer films;

FIG. 19 is magnetic spectra of Fe₇₂N₁₈B₁₀/Fe₈₂N₁₈/Fe₈₂N₁₈B₁₀ tri-layer films;

FIG. 20 shows the relationship between effective resistivity and total tri-layer film_thickness of an Fe₇₂N₁₈B₁₀/Fe₈₃Ta₆N₁₈/Fe₇₂N₁₈B₁₀ tri-layered structure;

FIG. 21 is magnetic spectra of an Fe₇₂N₁₈B₁₀/Fe₇₂Ta₁₈N₁₀/Fe₇₂N₁₈B₁₀ tri-layered structure;

FIG. 22 is magnetic spectra for Fe₈₂N₁₈/Ta₈₈N₁₂ bilayer films;

FIG. 23 is magnetic spectra for Fe₇₂N₁₈B₁₀/Ta₈₈N₁₂ bilayer films;

FIG. 24 is magnetic spectra for Fe₈₃Ta₆N₁₁/Ta₈₈N₁₂ bilayer films;

FIG. 25 shows magnetic permeability at 0.5 GHz for a single layer, bi-layer and tri-layer FeN-based films;

FIG. 26 is a Snoek product diagram at 0.5 GHz for a single layer, bi-layer and tri-layer FeN-based multi-layered structure;

FIG. 27 shows magnetic permeability at 0.5 GHz for a single layer, bi-layer and tri-layer FeTaN-based multi-layered structure; and

FIG. 28 is a Snoek product diagram at 0.5 GHz for a single layer, bi-layer and tri-layer FeTaN-based multi-layered structure.

### DETAILED DESCRIPTION

The inventors hereof have developed multilayer magnetic films with a combination of high magnetic permeability, low loss, and excellent inductance over a broad frequency range. The magnetic thin-films integrated with complementary metal-oxide-semiconductor (CMOS) enable high-quality, high density, low-profile, on-chip/in-package inductive components.

The multilayer films are disposed on a substrate, and include a first magnetic layer, wherein the first magnetic layer comprises Fe₍₅₀₋₈₀₎N₍₁₀₋₂₀₎B₍₁₋₂₀₎M₍₀₋₁₀₎, wherein M is Si, Ta, Zr, Ti, Co, Nb, or a combination thereof (herein referred to as FeNB); and a second magnetic layer wherein the second magnetic layer comprises Fe₍₅₀₋₉₀₎N₍₁₀₋₅₀₎ (herein referred to as FeN) or Fe₍₆₀₋₉₀₎N₍₁₋₁₀₎Ta₍₅₋₃₀₎ (herein referred to as FeNTa). The multilayer magnetic films can operate over a frequency range of 50 MHz to 10 GHz and can have a magnetic constant (also known as a magnetic permeability) of greater than or equal to 1800 and a magnetic loss tangent of less than or equal to 0.3 measured over a selected frequency band.

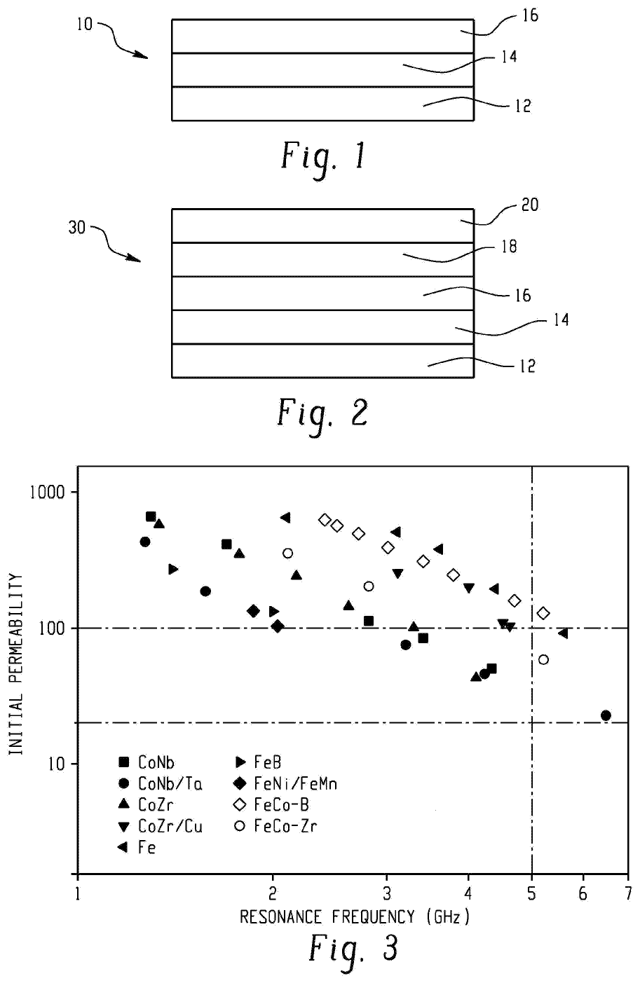

An illustration of a cross-sectional view of a multilayer magnetic film 10 is shown in FIG. 1. Substrate 12 has a first side, i.e., a first planar surface and a second side, i.e., an opposite second planar surface. The substrate 12 can be of any suitable material, for example a glass, an organic polymer, or a ceramic. In an aspect, the substrate comprises a ceramic such as at least one of MgO, Sic, Si₃N₄, alumina, silicon, or the like. The substrate can be amorphous, single crystal, or polycrystalline. The substrate 12 can have any suitable thickness, which will depend on its support properties and the intended application. For example, the substrate can have a thickness of 100 micrometers to 1 millimeters.

The first magnetic layer 14 is disposed on the first side of the first planar surface. As stated above, the first magnetic layer comprises Fe₍₅₀₋₈₀₎N₍₁₀₋₁₀₎B₍₁₋₂₀₎M₍₀₋₁₀₎, wherein M is Si, Ta, Zr, Ti, Co, Nb, or a combination thereof. In a preferred aspect, the first magnetic layer comprises Fe₍₅₀₋₈₀₎N₍₁₀₋₂₀₎B₍₁₋₂₀₎, wherein the amount of M is 0. The first magnetic layer can have a thickness of 10 to 100 nanometers, for example 10 to 50 nanometers or 20 to 80 nanometers.

A second magnetic layer 16 is disposed on a side of the first magnetic layer opposite the substrate. The second magnetic layer comprises Fe₍₅₀₋₉₀₎N₍₁₀₋₅₀₎ or Fe₍₆₀₋₉₀₎N₍₁₋₁₀₎Ta₍₅₋₃₀₎. The second magnetic layer can have a thickness of 10 to 400 nanometers, for example 10 to 300 nanometers, or 50 to 400 nanometers.

The multilayer magnetic film can include additional layers, in particular additional alternating first and second layers. As shown in FIG. 2, an additional first magnetic layer 16, comprising Fe₍₅₀₋₈₀₎N₍₁₀₋₂₀₎B₍₁₋₂₀₎, is disposed on the second magnetic layer 14. An additional second magnetic layer 18, comprising Fe₍₅₀₋₉₀₎N₍₁₀₋₅₀₎ or Fe₍₆₀₋₉₀₎N₍₁₋₁₀₎Ta₍₅₋₃₀₎, is disposed on the additional first magnetic layer 16. Further additional first and second magnetic layers can be disposed on the additional second magnetic layer in alternation (not shown).

The first magnetic layer 14 and the second magnetic layer 16 can have a total thickness of 20 to 500 nanometers. In an embodiment the first magnetic layer 14 has a thickness of 10 to 200 nm, and the second magnetic layer can have a thickness of 10 to 400 nm. In a particularly advantageous feature, the thickness of each of the magnetic layers, the ratio of the thickness, or both, can be adjusted to obtain a desired magnetic loss tangent of the multilayer magnetic film, a desired magnetic anisotropy of the magnetic multilayer film, or both.

A method of forming the multilayer magnetic film includes depositing the first magnetic layer onto a side of the substrate; and depositing the second magnetic layer onto a side of the first magnetic layer opposite to the substrate. Deposition of alternating layers proceeds until the entire film is manufactured. Deposition can be by rf/DC sputtering, electron beam deposition, or a combination thereof.

The multilayer magnetic films can be used over a frequency range of 50 MHz to 10 GHz, preferably over a frequency range of 100 MHz to 5 GHz, more preferably over a frequency range of 1 to 5 GHz.

The multilayer magnetic films can have a magnetic permeability of greater than or equal to 1800, preferably greater than or equal to 2000, more preferably greater than or equal to 3000, or 1800 to 5000 over a selected frequency band in the frequency range, preferably over a frequency band of 1 to 10 GHz. As used herein, this terminology refers to the multilayer magnetic films having at least one instance of the magnetic permeability being greater than or equal to 1800 over the frequency band of 1 to 5 GHz, or 1 to 10 GHz.

The multilayer magnetic films can have a magnetic loss tangent of less than or equal to 0.3, or less than 0.3, preferably less than or equal to 0.1, or less than 0.1, or 0.01 to 0.3 over a selected frequency band in the frequency range, preferably over a frequency band of 1 to 10 GHz. As used herein, this terminology refers to the multilayer magnetic films having at least one instance of the magnetic loss tangent being less than or equal to 0.3 over the frequency band of 1 to 5 GHz, or 1 to 10 GHz.

The multilayer magnetic films can have a cutoff frequency of greater than or equal to 1 GHz, or greater than 1 GHz, or greater than or equal to 2 GHz, preferably greater than or equal to 5 GHz, or 1 to 8 GHz.

The multilayer magnetic films can include additional layers, for example, a top layer. The top layer can include Al₂O₃. The top layer can include an insulating cap.

The multilayer magnetic films can be used in electronic devices such as filters or inductors on electronic integrated circuit chips for a wide variety of applications, for example, electric power applications, data storage, and microwave communication. The multilayer magnetic film can be used in low frequency applications, for example, at a frequency of 50 MHz to 1 GHz, or in high frequency applications, for example 1 to 10 GHz. The multilayer magnetic film can be used in antennas, and in electronic devices such as mobile internet devices, and in electronic devices, for example, cell phones, tablets, desktop computers, laptop computers, notebook computers, and the like. In an aspect, the device is a portable electronic device, for example a handheld electronic device. The multilayer magnetic films can further be used in power supply systems and antennas. The multilayer magnetic films can advantageously be used in integrated electronic devices.

The following examples are provided to illustrate the present disclosure. The examples are merely illustrative and are not intended to limit devices made in accordance with the disclosure to the materials, conditions, or process parameters set forth therein.

### EXAMPLES

FIG. 3 is a plot showing initial magnetic permeability versus resonance frequency/gigahertz (GHz) of various comparative films, reproduced from Chin. Phys. B Vol. 24, No. 5 (2015) 05750.

### Example 1

### FeN/FeNB/Glass Bi-Layered Film Structure

### Parameters for RF Magnetron Sputtering:

RF Power=80 to 120 Watts (W)
Deposition pressure=0.3 to 0.6 pascals (Pa)
Distance between target and substrate=8 centimeters (cm)
Working gas: Argon; Reaction gas: Nitrogen
Target:
   Iron (99.9%), 2-inch (5.08 cm) disk;
   2 pieces of boron (99.9%) chip with 2.5×2.5 square millimeters (mm²)
Deposition time: 5 to 30 minutes
Deposition temperature: ambient
Substrate: Optical glass

### Single Layer of FeN Film on Glass Substrate (Reference Example)

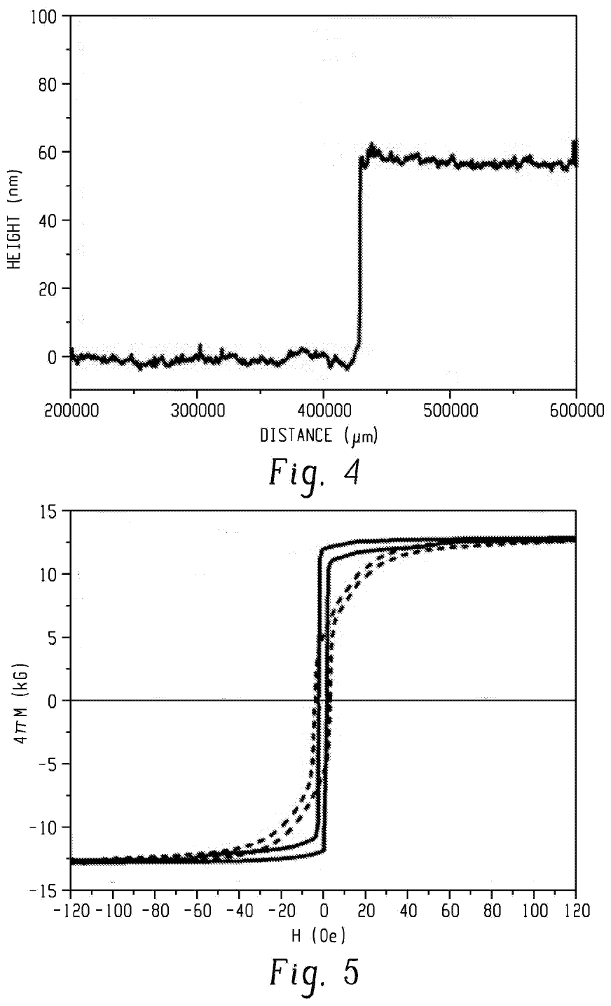

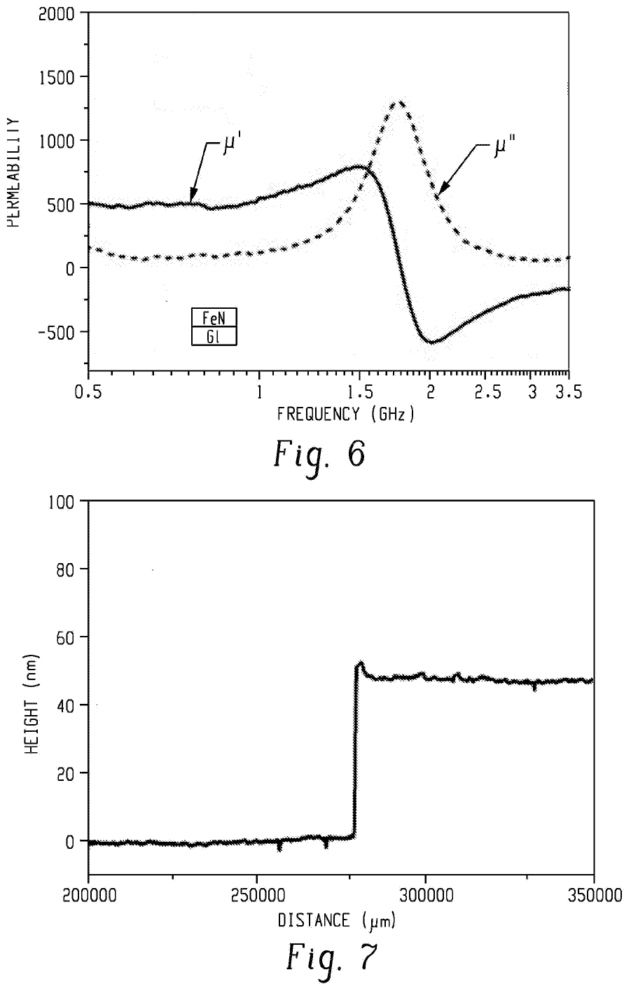

With reference to FIGS. 4-6, an FeN film had a composition of Fe₇₄N₂₆ and thickness of 60 nanometers (nm) on a glass substrate, measured by (energy-dispersive X-ray spectroscopy) EDXS and profilometry, respectively. In the figures, the abbreviation G1 stands for glass. The FeN film having a film thickness of 60 nm exhibited a fine grain size of 11 nm by atomic force microscopy (AFM). The FeN film exhibited magnetic anisotropy in the film plane depicted in magnetic hysteresis loops. The FeN film had a magnetic permeability (μ′) of 510 at 0.5 gigahertz (GHz) and a magnetic loss tangent (tan δ) of 0.3 and retained a resonance frequency of 1.71 GHz. The FeN film had a Snoek product of 0.87×10¹². A summary of magnetic properties for the 60 nm thick FeN film on glass substrate is provided in Table 1. In FIGS. 5 and 13, Easy (solid lines) or Hard (dashed lines) magnetizing direction indicates an energetically favorable or unfavorable direction of spontaneous magnetization, respectively.

TABLE 1

| Film thickness | 0.5 GHz | | 1 GHz | | 1.5 GHz | | fᵣ | Snoek product | 47πMs | Hc |
|---|---|---|---|---|---|---|---|---|---|---|
| (nm) | μ’ | tanδ | μ’ | Tanδ | μ’ | tanδ | (GHz) | (× 10¹²) | (kG) | (Oe) |
| 60 | 510 | 0.31 | 539 | 0.22 | 788 | 0.84 | 1.71 | 0.87 | 12.43 | 1.9 |

### Single Layer of FeNB Film on Glass Substrate (Reference Example)

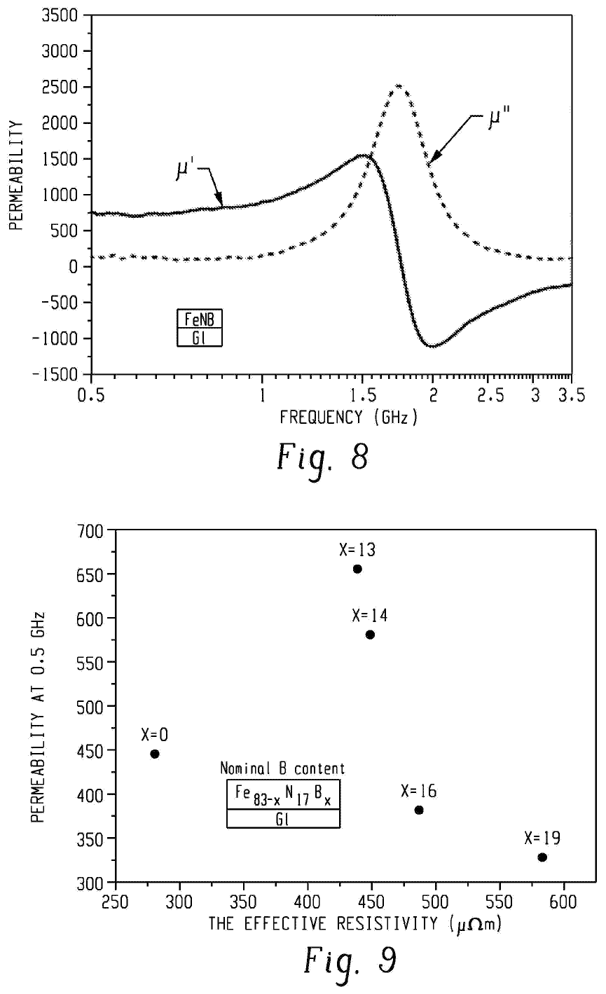

With reference to FIGS. 7 and 8, the FeNB film on a glass substrate had a composition of Fe₆₆N₁₈B₁₆ and thickness of 50 nm and an average grain size of 6.7 nm, measured by EDXS and profilometry, respectively. The FeNB film on a glass exhibited a magnetic permeability of 864 at 1 GHz and Snoek product of 1.26×10¹², respectively. A summary of magnetic measurements for the Fe₆₆N₁₈B₁₆film is provided in Table 2.

TABLE 2

| Film | | | | | | | | Snoek |
|---|---|---|---|---|---|---|---|---|
| thickness | 0.5 GHz | | 1 GHz | | 1.5 GHz | | fᵣ | product |
| (nm) | μ’ | tanδ | μ’ | Tanδ | μ’ | tanδ | (GHz) | (× 10¹²) |
| 50 | 730 | 0.19 | 864 | 0.18 | 1547 | 0.80 | 1.73 | 1.26 |

With reference to FIG. 9, the effective resistivity of the FeNB film increased with an increase in the content of boron (x=0, 13, 14, 16, 19). The magnetic permeability at 0.5 GHz was increased in the resistivity range from 400 to 450 microohm meters (μΩm).

### FeN/FeNB Bi-Layer on a Glass Substrate

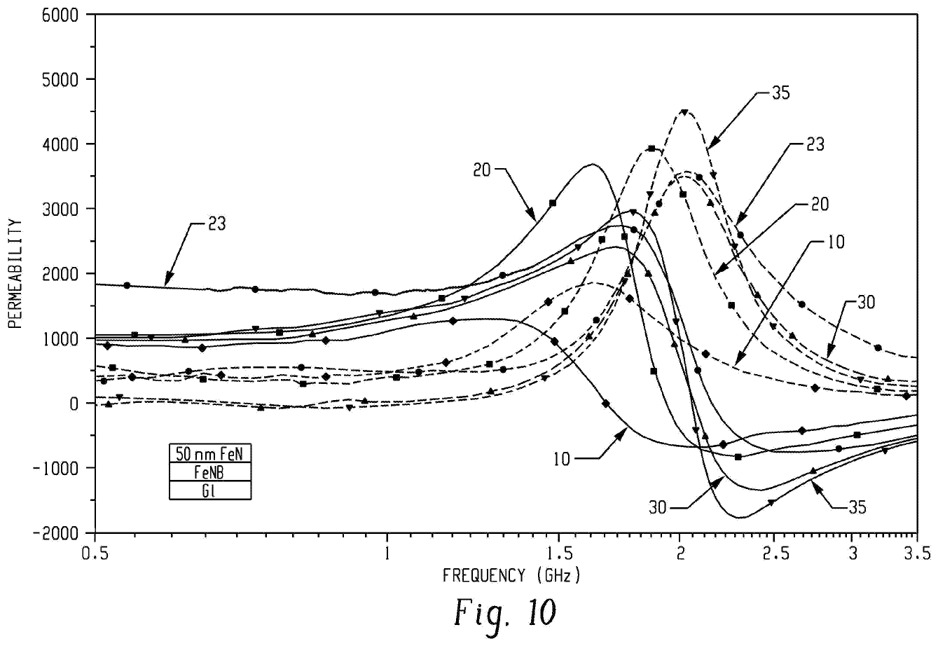

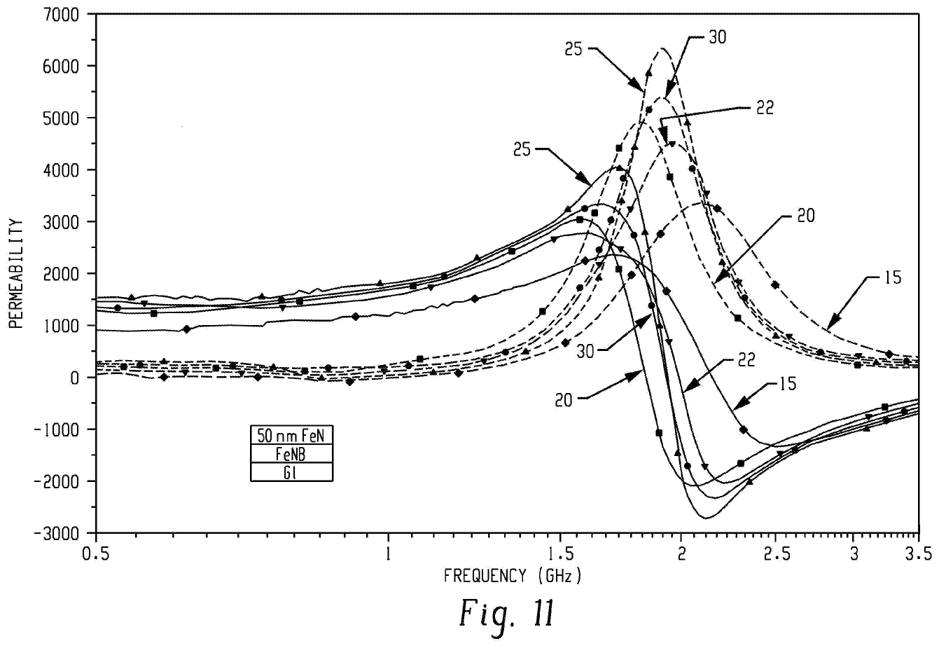

An Fe₆₆N₁₈B₁₆ film was deposited onto a glass substrate, followed by deposition of an Fe₇₄N₂₆ film with a constant thickness of 50 nm. The thickness of the Fe₆₆N₁₈B₁₆ film was in a range of 10-35 nm, varying with deposition time. FIG. 10 shows μ′ (solid lines) and μ″ (dashed lines) for varying thicknesses of the Fe₆₆N₁₈B₁₆ film in nm as indicated on the figure.

With reference to FIG. 10, an FeN (50 nm)/FeNB (23 nm) bi-layer film exhibited a high magnetic permeability of 1832 at 0.5 GHz and Snoek product of 3.72×10¹², respectively. The FeN (50 nm)/FeNB (23 nm) bi-layer film exhibited high magnetic permeability of 2313 at 1.5 GHz. The composition of the FeNB film was measured to be Fe₆₆N₁₈B₁₆ by EDXS. A summary of magnetic measurements for the FeN/FeNB bi-layered films with different thicknesses of the FeNB layer is provided in Table 3.

TABLE 3

| Film | | | | | | | | Snoek |
|---|---|---|---|---|---|---|---|---|
| thickness | 0.5 GHz | | 1 GHz | | 1.5 GHz | | fᵣ | product |
| (nm) | μ’ | tanδ | μ’ | tanδ | μ’ | tanδ | (GHz) | (× 10¹²) |
| 10 | 899 | 0.44 | 1103 | 0.44 | 853 | 1.98 | 1.62 | 1.46 |
| 20 | 1062 | 0.53 | 1366 | 0.30 | 3221 | 0.41 | 1.83 | 1.94 |
| 23 | 1832 | 0.21 | 1679 | 0.27 | 2313 | 0.33 | 2.03 | 3.72 |
| 30 | 1042 | 0.02 | 1275 | 0.01 | 2069 | 0.29 | 2.01 | 2.09 |
| 35 | 853 | 0.09 | 1375 | 0.01 | 2201 | 0.23 | 2.01 | 1.71 |

### Example 2

### FeN/FeNB/Glass Bi-Layered Film Structure with Low Level of Boron Content Parameters for RF Magnetron Sputtering

RF Power=80 to 120 W
Deposition pressure=0.3 to 0.6 pascals (Pa)
Distance between target and substrate=8 centimeters (cm)
Working gas: Ar; Reaction gas: Nitrogen
Target:
   Iron (99.5%), 2-inch disk
   2 pieces of boron (99.5%) chip with 2.5×2.5 mm²
Deposition time: 5 to 30 minutes
Deposition temperature: ambient
Substrate: Optical glass

In this example, an FeNB film was deposited onto a glass substrate, followed by a 50 nm thick FeN film deposited on the top of the FeNB film at ambient temperature. The thickness of the FeNB film varied with deposition time, and a constant thickness of 50 nm for the FeN film was retained.

Magnetic Permeability Spectra for FeN/FeNB Films with Low Level of Boron Content

With reference to FIG. 11, the FeNB film had a composition of Fe₇₂N₁₈B₁₀, and the FeN had a composition of Fe₇₄N₂₆ measured by EDXS. FIG. 11 shows (solid lines) and μ″ (dashed lines) for varying thicknesses of the Fe₆₆N₁₈B₁₀ film in nm as indicated on the figure. The bi-layered film structure exhibited an increased magnetic permeability from 1207 to 1741 with an increased thickness of the FeNB seed layer from 15 nm to 25 nm. The Snoek product of the FeN/FeNB film increased by 60% with an increase of thickness of the FeNB seed layer from 15 nm to 25 nm. A summary of magnetic spectrum measurements for the Fe₇₄N₂₆/Fe₇₂N₁₈B₁₀ bi-layer films is provided in Table 4.

TABLE 4

| FeNB thickness in FeN | 0.5 GHz | | 1 GHz | | 1.5 GHz | | fᵣ | Snoek product |
|---|---|---|---|---|---|---|---|---|
| (50 nm)/FeNB/Glass (nm) | μ’ | tanδ | μ’ | tanδ | μ’ | tanδ | (GHz) | (× 10¹²) |
| 15 | 895 | 0.08 | 1207 | 0.04 | 2023 | 0.31 | 2.08 | 1.86 |
| 20 | 1248 | 0.18 | 1707 | 0.15 | 2951 | 0.58 | 1.81 | 2.26 |
| 22 | 1427 | 0.11 | 1599 | 0.05 | 2690 | 0.45 | 1.96 | 2.80 |
| 25 | 1561 | 0.18 | 1741 | 0.06 | 3094 | 0.27 | 1.91 | 2.98 |
| 30 | 1297 | 0.16 | 1657 | 0.13 | 2972 | 0.38 | 1.91 | 2.48 |

### Resistivity Versus Magnetic Permeability (at 0.5 GHz) for a FeN/FeNB/Glass Structure

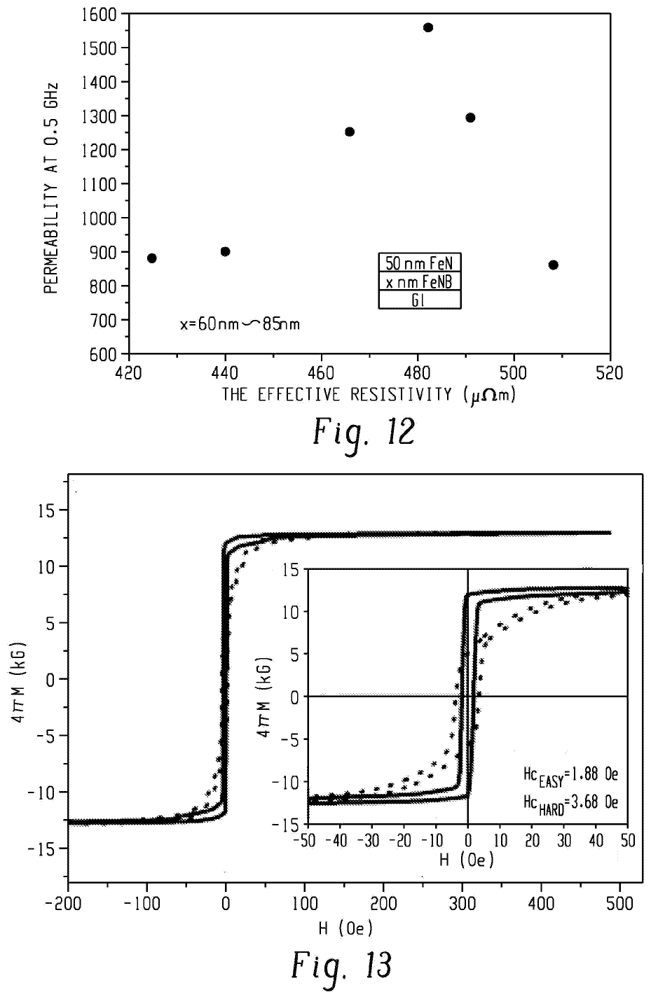

With reference to FIG. 12, the effective resistivity of the FeN/FeNB/Glass film was affected by the thickness of the FeNB seed layer. The resistivity increased with an increase of the FeNB thickness. Magnetic permeability at 0.5 GHz was increased in the resistivity range from 460 to 490 μΩm.

### Example 3

### FeTaN/FeNB/Glass Bi-Layered Structure Parameters for RF Magnetron Sputtering

RF Power=80 to 120 W
Deposition pressure=0.3 to 0.6 pascals (Pa)
Distance between target and substrate=8 centimeters (cm)
Working gas: Ar (99.5%); Reaction gas: Nitrogen (99.0%)
Target:
   Iron (99.5%), 2-inch disk
   2 pieces of boron (99.5%) chip with 5×5 mm²
Deposition time: 5 to 30 minutes
Deposition temperature: ambient
Substrate: Optical glass

### Magnetic Properties and Magnetic Permeability of Single FeTaN Film on a Glass Substrate

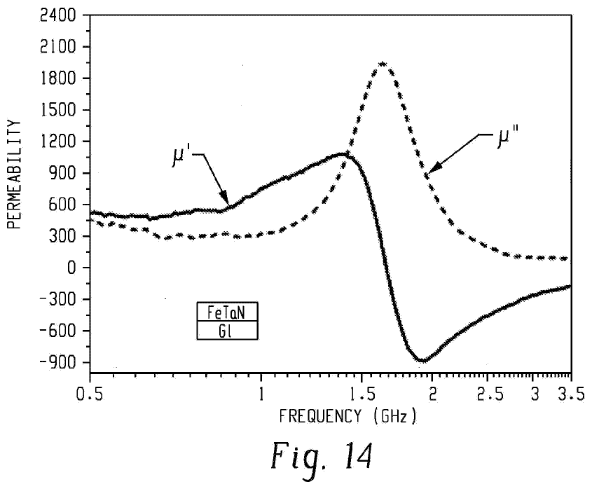

With reference to FIGS. 13 and 14, a summary of magnetic spectrum measurements for a Fe₇₄Ta₆N₂₀ single film is provided in Table 5.

TABLE 5

| Film thickness | 0.5 GHz | | 1 GHz | | 1.5 GHz | | fᵣ | Snoek product | 47πMs | Hc |
|---|---|---|---|---|---|---|---|---|---|---|
| (nm) | μ’ | tanδ | μ’ | Tanδ | μ’ | tanδ | (GHz) | (× 10¹²) | (kG) | (Oe) |
| 80 | 539 | 0.85 | 752 | 0.41 | 876 | 1.78 | 1.63 | 0.88 | 12.9 | 1.88 |

### Magnetic Permeability of Bi-Layered FeTaN/FeNB Films on the Glass Substrate

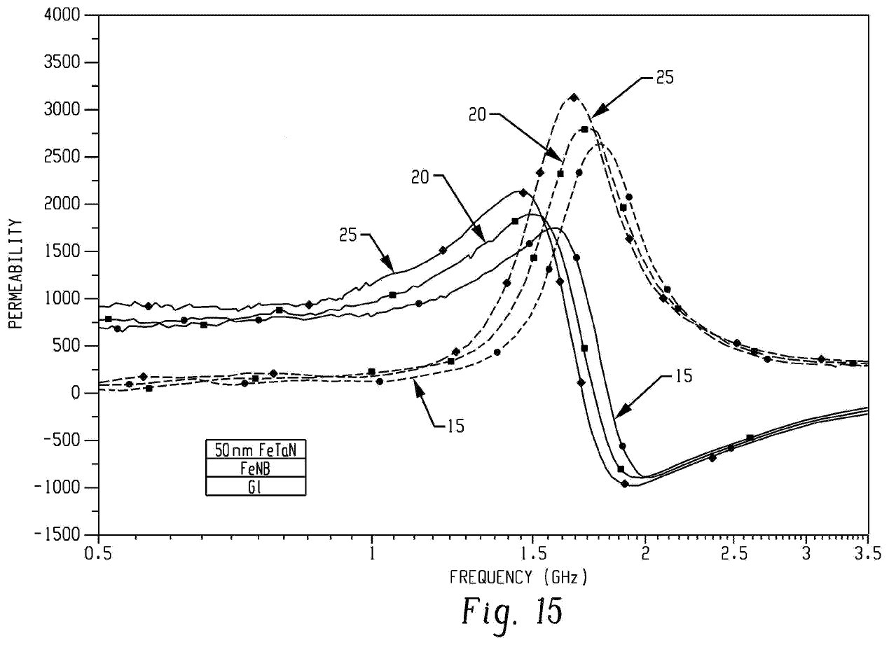

With reference to FIG. 15, the bi-layered film structure included Fe₇₄Ta₆N₂₀ and Fe₆₆N₁₈B₁₆ films deposited on a glass substrate. A summary of magnetic spectrum measurements for Fe₇₄Ta₆N₂₀/Fe₆₆N₁₈B₁₆ bilayer films is provided in Table 6.

TABLE 6

| FeNB thickness in FeTaN(50 | 0.5 GHz | | 1 GHz | | 1.5 GHz | | fᵣ | Snoek product |
|---|---|---|---|---|---|---|---|---|
| nm)/FeNB/Glass (nm) | μ’ | tanδ | μ’ | tanδ | μ’ | tanδ | (GHz) | (× 10¹²) |
| 15 | 913 | 0.10 | 814 | 0.14 | 1621 | 0.55 | 1.70 | 1.55 |
| 20 | 1167 | 0.03 | 953 | 0.24 | 1882 | 0.78 | 1.61 | 1.88 |
| 22 | 1130 | 0.11 | 1168 | 0.13 | 2044 | 1.02 | 1.88 | 1.88 |

### Resistivity Versus Magnetic Permeability (at 0.5 GHz) for a FeTaN/FeNB/Glass Structure

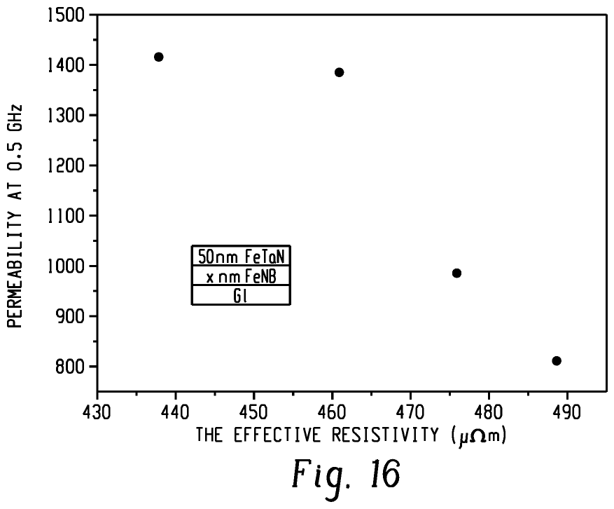

With reference to FIG. 16, the effective resistivity of the FeNB/FeTaN film was affected by the thickness of the FeNB layer. The effective resistivity increased from 438 μΩm to 489 μΩm with an increase of the FeNB thickness from 60 nm to 75 nm. High magnetic permeability was exhibited in a resistivity range from 430 to 460 μΩm.

### Example 4

### FeTaN/FeNB/Glass Bi-Layer Film Structure with Low Level of Boron Content Parameters for RF Magnetron Sputtering

RF Power=80 to 120 W
Deposition pressure=0.3 to 0.6 pascals (Pa)
Distance between target and substrate=8 centimeters (cm)
Working gas: Ar (99.5%); Reaction gas: Nitrogen (99.0%)
Target:
   Iron (99.5%), 2-inch disk
   2 pieces of boron (99.5%) chip with 5×5 mm²
   1 piece for tantalum (99.99%) (5×5 mm²)
Deposition time: 5 to 30 minutes
Deposition temperature: ambient
Substrate: Optical glass
   Magnetic Permeability Spectrum of in FeTaN/FeNB Film with Low Level of B Concentration

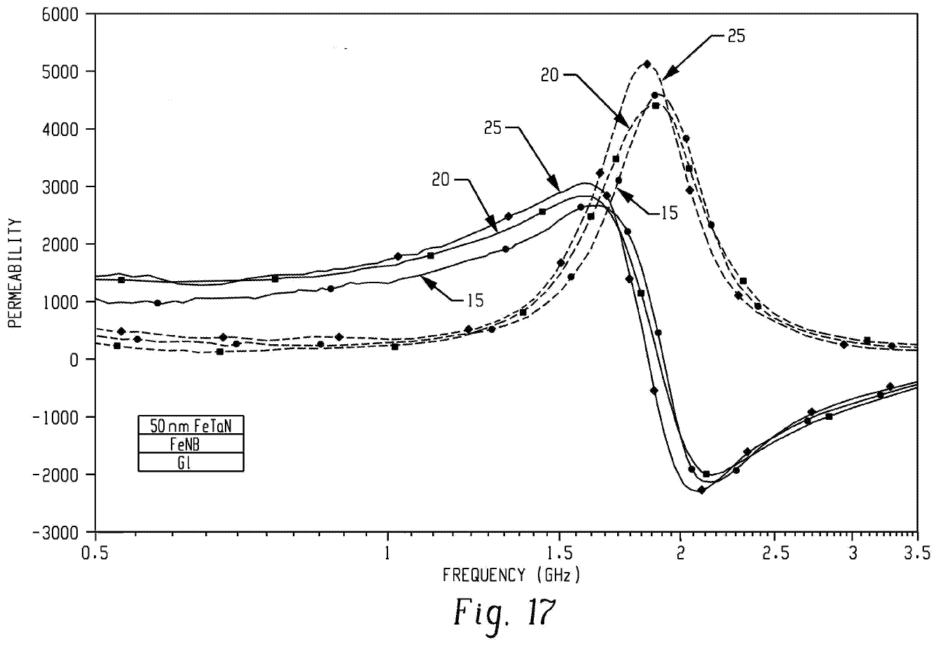

With reference to FIG. 17, the FeTaN film had a composition of Fe₇₄Ta₆N₂₀ measured by EDXS, and FeNB had a composition of Fe₇₂N₁₈B₁₀ FIG. 17 shows μ′ (solid lines) and μ″ (dashed lines) for varying thicknesses of the Fe₇₂N₁₈B₁₀ film in nm as indicated on the figure. A summary of magnetic spectrum measurements for Fe₇₄Ta₆N₂₀/Fe₇₂N₁₈B₁₀ bilayer films on a glass substrate is provided in Table 7.

TABLE 7

| FeNB thickness in FeTaN | 0.5 GHz | | 1 GHz | | 1.5 GHz | | fᵣ | Snoek product |
|---|---|---|---|---|---|---|---|---|
| (50 nm)/FeNB/Glass (nm) | μ’ | tanδ | μ’ | tanδ | μ’ | tanδ | (GHz) | (× 10¹²) |
| 15 | 985 | 0.52 | 1716 | 0.18 | 2850 | 0.54 | 1.90 | 1.87 |
| 20 | 1386 | 0.18 | 1602 | 0.12 | 2680 | 0.51 | 1.87 | 2.59 |
| 22 | 1416 | 0.27 | 1796 | 0.16 | 2351 | 0.47 | 1.83 | 2.59 |

### Example 5

### FeNB/FeN/FeNB/Glass Tri-Layered Structure Parameters for RF Magnetron Sputtering

RF Power=80 to 120 W
Deposition pressure=0.3 to 0.6 pascals (Pa)
Distance between target and substrate=8 centimeters (cm)
Working gas: Ar (99.5%); Reaction gas: Nitrogen (99.0%)
Target:
   Iron (99.5%), 2-inch disk
   2 pieces of boron (99.5%) chip with 5×5 mm²
   1 piece for tantalum (99.99%) (5×5 mm²)
Deposition time: 5 to 30 minutes
Deposition temperature: ambient
Substrate: Optical glass

### Resistivity of FeNB/FeN/FeNB Structure

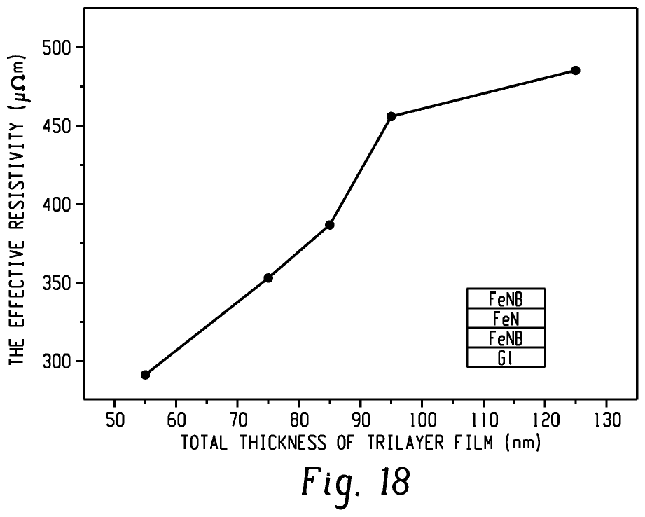

With reference to FIG. 18, the effective resistivity of a tri-layer film was measured by the V.D. Pauw method with four probes. The resistivity increased from 291 to 485 μΩm for the total thickness of the tri-layer film from 55 to 125 nm. Details of film thickness and resistivity for Fe₇₂N₁₈B₁₀/Fe₈₂N₁₈/Fe₇₂N₁₈B₁₀ tri-layer films are provided in Table 8.

TABLE 8

| Top layer | Middle layer | Bottom layer | Total thickness | Resistivity |
|---|---|---|---|---|
| FeNB (nm) | FeN (nm) | FeNB (nm) | (nm) | (μΩm) |
| 15 | 20 | 20 | 55 | 291 |
| 15 | 30 | 30 | 75 | 351 |
| 15 | 35 | 35 | 85 | 386 |
| 20 | 50 | 25 | 95 | 455 |
| 25 | 50 | 50 | 125 | 485 |

### Magnetic Permeability for FeNB/FeN/FeNB/Glass Structure

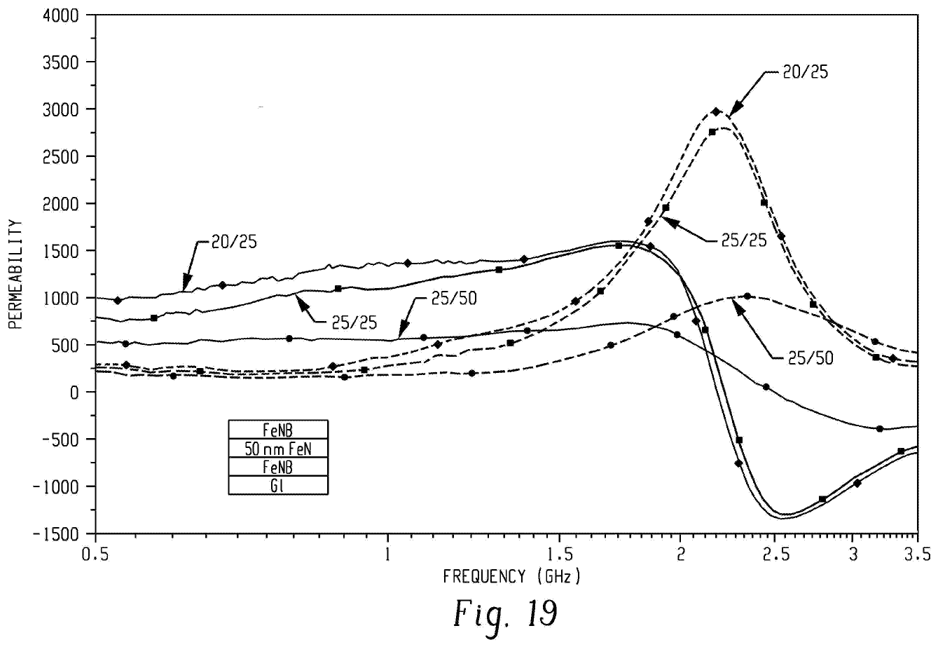

With reference to FIG. 19, the thickness of 50 nm for the FeN middle layer was fixed and the thicknesses of the top and bottom FeNB layer were changed. FIG. 19 shows μ″ (solid lines) and μ″ (dashed lines) for varying thicknesses of the top and bottom FeNB films in nm as indicated on the figure. The increased magnetic permeability (at 0.5 GHz) and Snoek product were 995 and 2.16 for the FeNB(20 nm)/FeN(50 nm)/FeNB(25 nm) structures, respectively. Magnetic permeability of the FeNB(20 nm)/FeN(50 nm)/FeNB(25 nm) structure was about 50% higher than the FeNB(25 nm)/FeTaN(50 nm)/FeNB(25 nm) structure. A summary of magnetic spectrum measurements for Fe₇₂N₁₈B₁₀/Fe₈₂N₁₈/Fe₇₂N₁₈B₁₀ tri-layer films is shown in Table 9. The last row includes details of the reference sample.

TABLE 9

| Top layer | | | | | | | | | | |
|---|---|---|---|---|---|---|---|---|---|---|
| FeNB | Middle layer | Bottom layer | μ’ at 0.5 GHz | | μ’ at 1.0 GHz | | μ’ at 1.5 GHz | | fᵣ | Snoek product |
| (nm) | FeN (nm) | FeNB (nm) | μ’ | tanδ | μ’ | tanδ | μ’ | tanδ | (GHz) | (× 10¹²) |
| 20 | 50 | 25 | 995 | 0.28 | 1339 | 0.27 | 1478 | 0.58 | 2.17 | 2.16 |
| 25 | 50 | 25 | 773 | 0.33 | 1096 | 0.25 | 1444 | 0.53 | 2.21 | 1.71 |
| 25 | 50 | 50 | 530 | 0.43 | 559 | 0.31 | 692 | 0.46 | 2.25 | 1.19 |
| 25 | 50 (FeTaN) | 25 | 382 | 0.41 | 457 | 0.16 | 464 | 0.96 | 1.79 | 0.68 |

### Example 6

### FeNB/FeTaN/FeNB/Glass Tri-Layered Structure Parameters for RF Magnetron Sputtering

RF Power=80 to 120 W
Deposition pressure=0.3 to 0.6 pascals (Pa)
Distance between target and substrate=8 centimeters (cm)
Working gas: Ar (99.5%); Reaction gas: Nitrogen (99.0%)
Target:
   Iron (99.5%), 2-inch disk
   2 pieces of boron (99.5%) chip with 2.5×2.5 mm²
   1 piece for tantalum (99.99%) (5×5 mm²)
Deposition time: 5 to 30 minutes
Deposition temperature: ambient
Substrate: Optical glass

### Resistivity of FeNB/FeTaN/FeNB Structure

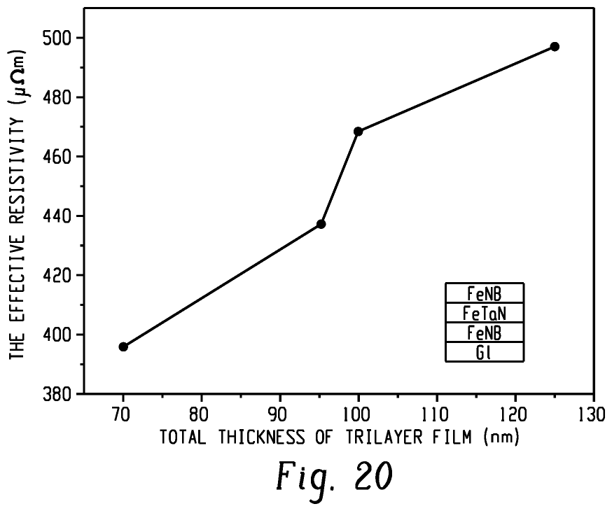

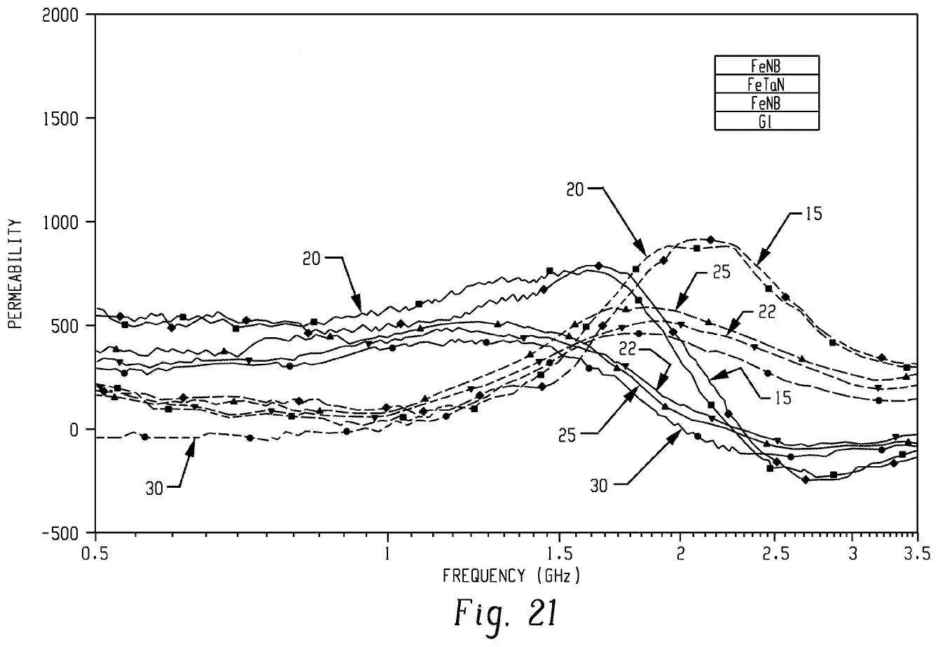

With reference to FIG. 20, the effective resistivity increased with an increase of total thickness of the tri-layer FeNB/FeTaN/FeNB film. The effective resistivity increased from 391 to 496 μΩm for the total thickness from 70 to 125 nm. The effective resistivity of the FeNB/FeTaN/FeNB film was about 5% higher than that of the FeNB/FeN/FeNB film. Details of film thickness and resistivity for the Fe₇₂N₁₈B₁₀/Fe₈₃Ta₆N₁₁/Fe₇₂N₁₈B₁₀ tri-layer structure are provided in Table 10.

TABLE 10

| Top layer | Middle layer | Bottom layer | Total thickness | Resistivity |
|---|---|---|---|---|
| FeNB (nm) | FeTaN (nm) | FeNB (nm) | (nm) | (μΩm) |
| 20 | 25 | 25 | 70 | 396 |
| 20 | 50 | 25 | 95 | 437 |
| 25 | 50 | 25 | 100 | 468 |
| 25 | 50 | 50 | 125 | 496 |

### Magnetic Permeability for FeNB/FeTaN/FeNB/Glass Structure

With reference to FIG. 21, the thickness of the FeNB and FeTaN layer varied from 20 nm to 50 nm. FIG. 21 shows μ′ (solid lines) and μ″ (dashed lines) for varying thicknesses of the top, middle, and bottom FeNB films in nm as indicated on the figure. The increased magnetic permeability (at 0.5 GHz) and Snoek product were 545 and 1.14 for the FeNB(20 nm)/FeTaN(25 nm)/FeNB(25 nm) structures, respectively. The magnetic permeability of the FeNB(20 nm)/FeTaN(25 nm)/FeNB(25 nm) structure was about 45% lower than that of the FeNB(20 nm)/FeN(50 nm)/FeNB(25 nm) structure (i.e., 995). A summary of magnetic spectrum measurements for Fe₇₂N₁₈B₁₀/Fe₇₂Ta₁₈N₁₀/Fe₇₂N₁₈B₁₀ tri-layer films is provided in Table 11. The last row includes details of the reference sample.

TABLE 11

| Top layer | | | | | | | | | | |
|---|---|---|---|---|---|---|---|---|---|---|
| FeNB | Middle layer | Bottom layer | μ’ at 0.5 GHz | | μ’ at 1.0 GHz | | μ’ at 1.5 GHz | | fᵣ | Snoek product |
| (nm) | FeN (nm) | FeNB (nm) | μ’ | tanδ | μ’ | tanδ | μ’ | tanδ | (GHz) | (× 10¹²) |
| 20 | 25 | 25 | 545 | 0.31 | 504 | 0.11 | 712 | 0.35 | 2.09 | 1.14 |
| 25 | 25 | 25 | 511 | 0.41 | 599 | 0.07 | 747 | 0.49 | 2.08 | 1.06 |
| 20 | 50 | 25 | 319 | 0.62 | 429 | 0.23 | 425 | 0.83 | 1.86 | 0.59 |
| 25 | 50 | 25 | 382 | 0.41 | 457 | 0.16 | 464 | 0.96 | 1.79 | 0.68 |
| 25 | 50 | 50 | 292 | 0.02 | 397 | 0.04 | 382 | 0.91 | 1.76 | 0.52 |
| 20* | 50 (FeN) | 25 | 995 | 0.28 | 1366 | 0.27 | 1478 | 0.58 | 2.17 | 2.16 |

*Reference example

### Example 7

### FeN, FeNB, FeTaN/TaN/Glass Bi-Layered Structure Parameters for RF Magnetron Sputtering

RF Power=80 to 120 W
Deposition pressure=0.3 to 0.6 pascals (Pa)
Distance between target and substrate=8 centimeters (cm)
Working gas: Ar (99.5%); Reaction gas: Nitrogen (99.0%)
Target:
   Iron (99.5%), 2-inch disk
   2 pieces of boron (99.5%) chip with 2.5×2.5 mm²
   1 piece for tantalum (99.99%) (5×5 mm²)
Deposition time: 5 to 30 minutes
Deposition temperature: ambient
Substrate: Optical glass

### Magnetic Permeability for FeN/TaN/Glass Structure

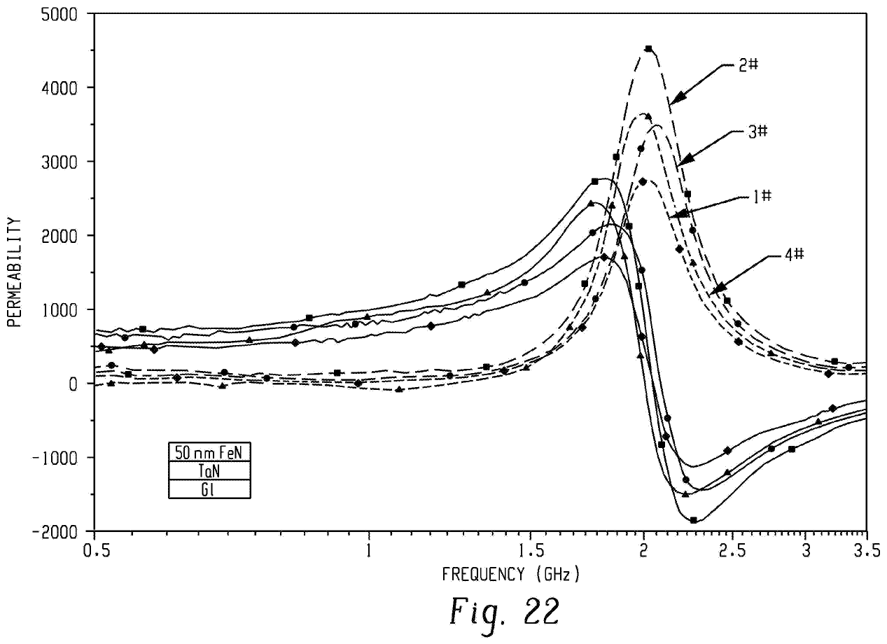

With reference to FIG. 22, a non-magnetic TaN film was a seed layer for the deposition of a 50 nm FeN film. FIG. 22 shows μ′ (solid lines) and μ″ (dashed lines) for varying thicknesses of the TaN films in nm as indicated on the figure. The thickness of non-magnetic TaN seed layer varied from 15 to 30 nm. The increased magnetic permeability and Snoek product were 716 at 0.5 GHz and 1.53 when the thickness of TaN layer was about 20 nm. The magnetic permeability of the FeN(50 nm)/TaN(20 nm)/Glass structure was about 20% lower than that of the FeN(50 nm)/FeTaN(10 nm)/Glass structure (i.e., 892). The magnetic seed layer resulted in frequency permeability higher than that of the non-magnetic seed layer (e.g., TaN). A summary of magnetic spectrum measurements for Fe₈₂N₁₈/Ta₈₈N₁₂ bilayer films is provided in Table 12. The last row includes details of the reference sample.

TABLE 12

| Top layer | Bottom layer | μ’ at 0.5 GHz | | μ’ at 1.0 GHz | | μ’ at 1.5 GHz | | fᵣ | Snoek product |
|---|---|---|---|---|---|---|---|---|---|
| FeN (nm) | TaN (nm) | μ’ | tanδ | μ’ | tanδ | μ’ | tanδ | (GHz) | (× 10¹²) |
| 50 | 15 | 507 | 0.22 | 558 | 0.05 | 1220 | 0.17 | 2.12 | 1.07 |
| 50 | 20 | 716 | 0.20 | 901 | 0.14 | 1939 | 0.17 | 2.13 | 1.53 |
| 50 | 25 | 646 | 0.34 | 778 | 0.05 | 1494 | 0.15 | 2.16 | 1.39 |
| 50 | 30 | 478 | 0.04 | 786 | 0.01 | 1648 | 0.09 | 2.09 | 1.00 |
| 50* | 20 (FeTaN) | 892 | 0.08 | 1145 | 0.13 | 1709 | 0.89 | 1.76 | 1.57 |

*Reference example

### Magnetic Permeability for FeNB/TaN/Glass Structure

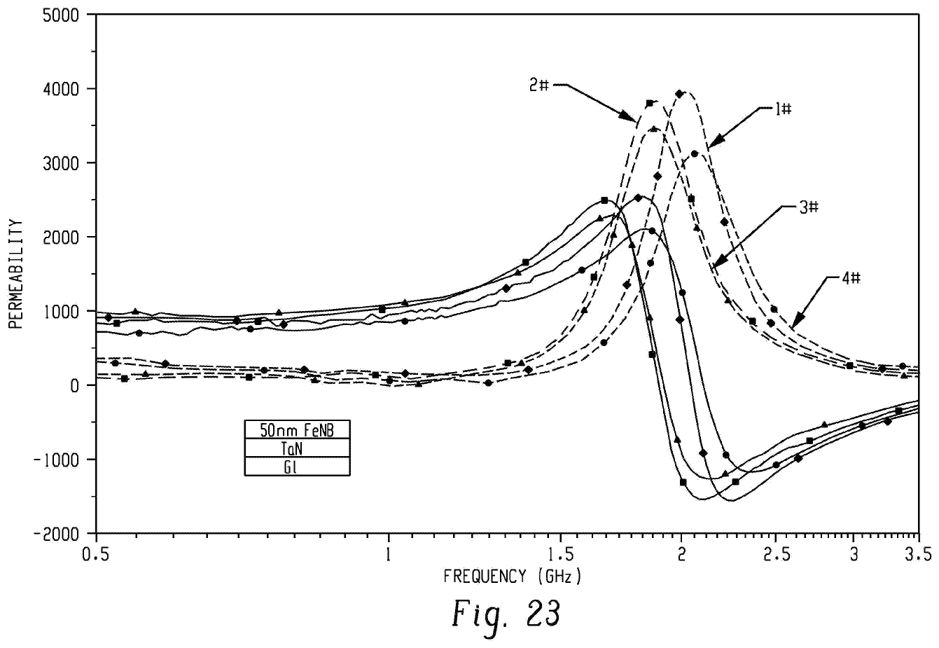

With reference to FIG. 23, the thickness of non-magnetic TaN seed layer varied from 10 nm to 25 nm. FIG. 23 shows μ′ (solid lines) and μ″ (dashed lines) for varying thicknesses of the TaN films in nm as indicated on the figure. The increased magnetic permeability and Snoek product were 937 at 0.5 GHz and 1.76 when the thickness of TaN seed layer was about 20 nm. The magnetic permeability of the FeN(50 nm)/TaN(20 nm)/Glass structure was about 32% lower than that of the FeNB(50 nm)/FeTaN(20 nm)/Glass structure (i.e., 1386). The magnetic permeability of the FeNB(50 nm)/TaN(20 nm)/Glass structure was about 24% higher than that of the FeN(50 nm)/TaN(20 nm)/Glass structure (i.e., 716). The magnetic seed layer demonstrated higher permeability than that of the non-magnetic seed layer. A summary of magnetic spectrum measurements for Fe₇₂N₁₈B₁₀/Ta₈₈N₁₂ bilayer films is provided in Table 12. The last two rows include details of the reference samples.

TABLE 12

| Top layer | Bottom layer | μ’ at 0.5 GHz | | μ’ at 1.0 GHz | | μ’ at 1.5 GHz | | fᵣ | Snoek product |
|---|---|---|---|---|---|---|---|---|---|
| FeN (nm) | TaN (nm) | μ’ | tanδ | μ’ | tanδ | μ’ | tanδ | (GHz) | (× 10¹²) |
| 10 | 10 | 821 | 0.58 | 941 | 0.09 | 1598 | 0.20 | 2.01 | 1.65 |
| 15 | 15 | 866 | 0.11 | 1043 | 0.12 | 2004 | 0.33 | 1.87 | 1.23 |
| 20 | 20 | 937 | 0.17 | 1065 | 0.01 | 1827 | 0.32 | 1.88 | 1.76 |
| 25 | 25 | 708 | 0.43 | 862 | 0.13 | 1378 | 0.16 | 2.06 | 1.46 |
| 50* | 20 (FeTaN) | 1386 | 0.15 | 1581 | 0.13 | 2740 | 0.17 | 1.87 | 2.59 |
| 50 (FeN)* | 20 | 716 | 0.20 | 901 | 0.14 | 1939 | 0.17 | 2.13 | 1.53 |

*Reference example

### Magnetic Permeability for FeTaN/TaN/Glass Structure

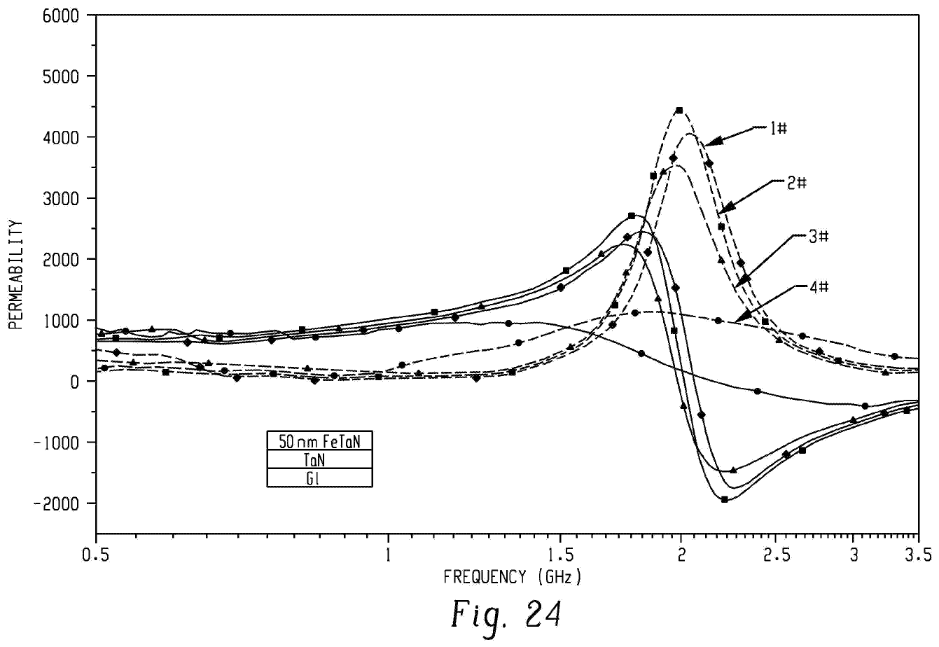

With reference to FIG. 24, the thickness of magnetic top FeTaN layer was fixed at 50 nm. FIG. 24 shows μ′ (solid lines) and μ″ (dashed lines) for varying thicknesses of the TaN films in nm as indicated on the figure. The thickness of nan-magnetic TaN layer varied from 10 nm to 25 nm. The increased magnetic permeability and Snoek product was 832 at 0.5 GHz and 1.63 when the thickness of TaN layer was about 20 nm. The magnetic permeability of the FeTaN(50 nm)/TaN(20 nm)/Glass structure was about 38% lower than of the FeTaN(50 nm)/FeNB(20 nm)/Glass structure (i.e., 1386). The magnetic permeability of the FeTaN(50 nm)/TaN(20 nm)/Glass structure was about 14% higher than that of the FeN(50 nm)/TaN(20 nm)/Glass structure (i.e., 716). A summary of magnetic spectrum measurements for Fe₈₃Ta₆N₁₁/Ta₈₈N₁₂ bilayer films is provided in Table 13. The last row includes details of the reference sample. The last two rows include details of the reference samples.

TABLE 13

| Top layer | Bottom layer | μ’ at 0.5 GHz | | μ’ at 1.0 GHz | | μ’ at 1.5 GHz | | fᵣ | Snoek product |
|---|---|---|---|---|---|---|---|---|---|
| FeN (nm) | TaN (nm) | μ’ | tanδ | μ’ | tanδ | μ’ | tanδ | (GHz) | (× 10¹²) |
| 10 | 10 | 669 | 0.68 | 911 | 0.18 | 1538 | 0.29 | 2.03 | 1.36 |
| 15 | 15 | 714 | 0.49 | 1029 | 0.10 | 1814 | 0.25 | 1.99 | 1.42 |
| 20 | 20 | 832 | 0.38 | 975 | 0.15 | 1697 | 0.29 | 1.96 | 1.63 |
| 25 | 25 | 807 | 0.30 | 906 | 0.28 | 984 | 0.89 | 1.83 | 1.48 |
| 50 | 20 (FeNB) | 1386 | 0.20 | 1581 | 0.14 | 2740 | 0.17 | 1.87 | 2.59 |
| 20 (FeN) | 20 | 716 | 0.17 | 901 | 0.01 | 1939 | 0.32 | 2.13 | 1.53 |

### Example 8

### Magnetic Permeability and Snoek Product Diagram of the FeN-Based or FeTaN-Based Multi-Layered Structure

Magnetic permeability (at 0.5 GHz) and Snoek product diagram of FeN-based structure

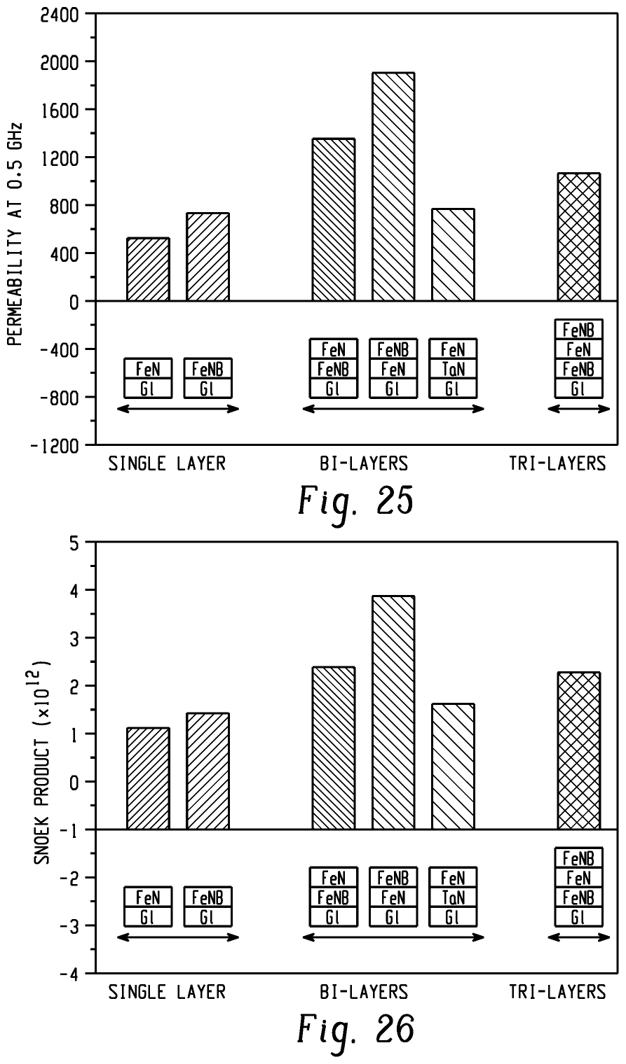

With reference to FIG. 25, the magnetic permeability diagram at 0.5 GHz of the FeN-based film are provided for the single layer film, double layers film and triple layer structure. The increased magnetic permeability about 1800 was observed in the double-layered film with the 20˜25 nm FeNB seed layer.

With reference to FIG. 26, the Snoek product diagram of the FeN-based film are provided for the single layer film, double layers film and triple layers film. The increased Snoek product about 2.0−3.5×10′² was observed in the double-layered film with the 20˜25 nm FeNB seed layer.

### Magnetic Permeability (at 0.5 GHz) and Snoek Product Diagram of FeTaN-Based Structure

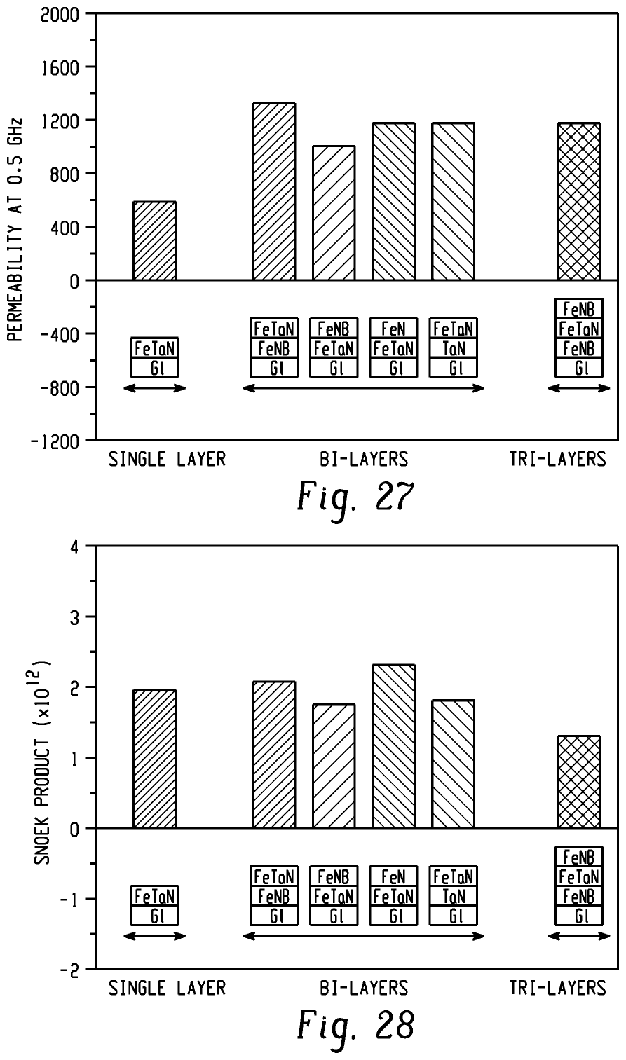

With reference to FIG. 27, the magnetic permeability diagram of the FeTaN-based film is provided for the single layer film, double layers film and triple layers film. The increased magnetic permeability about 1300 was observed in the double-layered film with the 20˜25 nm FeNB seed layer.

With reference to FIG. 28, the Snoek product diagram of the FeTaN-based film are provided for the single layer film, bi-layer film and triple-layer structure. The increased Snoek product about 2.0×10¹² was observed in the double-layered film with the 20˜25 nm FeTaN or FeNB seed layer.

Set forth below are some aspects of the multilayer magnetic film, articles comprising the same, and methods of making the same.

Aspect 1: A multilayer magnetic film, comprising: a substrate; a first magnetic layer disposed on the substrate, wherein the first magnetic layer comprises Fe₍₅₀₋₈₀₎N₍₁₀₋₂₀₎B₍₁₋₂₀₎M₍₀₋₁₀₎, wherein M is Si, Ta, Zr, Ti, Co, or a combination thereof; and a second magnetic layer disposed on the first magnetic layer, wherein the second magnetic layer comprises Fe₍₅₀₋₉₀₎N₍₁₀₋₅₀₎or Fe₍₆₀₋₉₀₎N₍₁₋₁₀₎Ta₍₅₋₃₀₎; wherein the multilayer magnetic film has, over a frequency range of 50 MHz to 10 GHz, preferably over a frequency range of 100 MHz to 5 GHz, more preferably over a frequency range of 1 to 5 GHz, a magnetic permeability of greater than or equal to 1800, preferably greater than 2000, more preferably greater than 3000, or 1800 to 5000 over a selected frequency band in the frequency range, preferably over a frequency band of 1 to 10 GHz; a magnetic loss tangent of less than or equal to 0.3, preferably less than or equal to 0.1, or 0.01 to 0.3 over a selected frequency band in the frequency range, preferably over a frequency band of 1 to 10 GHz; and a cutoff frequency of greater than or equal to 1 GHz, greater than or equal to 1 GHz, or greater than or equal to 2 GHz, preferably greater than or equal to 5 GHz, or 1 to 8 GHz.

Aspect 2: The multilayer magnetic film of Aspect 1, wherein the substrate comprises a glass, polymer, or ceramic, preferably a ceramic.

Aspect 3: The multilayer magnetic film of any one or more of the preceding Aspects, wherein the first magnetic layer has a thickness of 10 to 100 nanometers, and the second magnetic layer has a thickness of 10 to 400 nanometers.

Aspect 4: The multilayer magnetic film of any one or more of the preceding Aspects, further comprising: an additional first layer comprising Fe₍₅₀₋₈₀₎N₍₁₀₋₂₀₎B₍₁₋₂₀₎ disposed on the second layer; and an additional second magnetic layer comprising Fe₍₅₀₋₉₀₎N₍₁₀₋₅₀₎ or Fe₍₆₀₋₉₀₎N₍₁₋₁₀₎Ta₍₅₋₃₀₎ disposed on the additional first magnetic layer.

Aspect 5: The multilayer magnetic film of Aspect 4, comprising further additional first and second magnetic layers disposed on the additional second magnetic layer in alternation.

Aspect 6: The multilayer magnetic film of any one or more of Aspects 4 to 5, wherein the first magnetic layer and the second magnetic layer have a total thickness of 20 to 500 nanometers.

Aspect 7: An article comprising the multilayer film of any one or more of Aspects 1 to 6, preferably wherein the article is a filter, transformer, inductor, antenna, electronic integrated circuit chip, or electromagnetic shielding device.

Aspect 8: The article of Aspect 7, wherein the article is a component of an electronic device, preferably a mobile phone, a desktop computer, a laptop computer, a notebook computer, a wireless or LAN network, a power supply, an amplifier, a voltage-controlled oscillator, a shrink power converter, more preferably an integrated electronic device.

Aspect 9: A method of forming the multilayer magnetic film of any one or more of Aspects 1 to 6, the method comprising: depositing the first magnetic layer onto a side of the substrate; and depositing the second magnetic layer onto a side of the first magnetic layer opposite to the substrate.

Aspect 10: The method of Aspect 9, wherein the depositing comprises rf/DC sputtering, electron beam deposition, or a combination thereof.

Aspect 11: The method of Aspect 10, further comprising depositing an additional first layer on a side of the second layer opposite the first layer.

Aspect 12: The method of Aspect 11, further comprising depositing an additional second layer on a side of the additional first layer opposite the second layer.

Aspect 13: The method of any one or more of Aspects 9 to 12, comprising adjusting the thickness of each layer to adjust the magnetic loss tangent of the multilayer magnetic film, the magnetic anisotropy of the magnetic multilayer film, or both.

Aspect 14: A multilayer magnetic film made by the method of any one or more of Aspects 9 to 13.

“Film” as used herein includes planar layers, sheets, and the like as well as other three-dimensional non-planar forms. A layer can further be macroscopically continuous or non-continuous. As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. “Or” means “and/or.” Ranges disclosed herein are inclusive of the recited endpoint and are independently combinable. “Combination” is inclusive of blends, mixtures, alloys, reaction products, and the like. Also, “combination thereof” means that the list is inclusive of each element individually, as well as combinations of two or more elements of the list, and combinations of at least one element of the list with like elements not named. The terms “first,” “second,” and so forth, herein do not denote any order, quantity, or importance, but rather are used to distinguish one element from another. While certain combinations of features have been described herein, it will be appreciated that these certain combinations are for illustration purposes only and that any combination of any of these features can be employed, explicitly or equivalently, either individually or in combination with any other of the features disclosed herein, in any combination, and all in accordance with an embodiment. Any and all such combinations are contemplated herein and are considered within the scope of the disclosure. Unless otherwise stated, the test standards are the latest as of the date of filing.

The endpoints of all ranges directed to the same component or property are inclusive of the endpoints, are independently combinable, and include all intermediate points and ranges. For example, ranges of “up to 25, or 5 to 20” is inclusive of the endpoints and all intermediate values of the ranges of “5 to 25” such as 10 to 23, etc.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the disclosure has been described with reference to exemplary embodiments, it will be understood by those skilled in the art that various changes can be made, and equivalents can be substituted for elements thereof without departing from the scope of this disclosure. In addition, many modifications can be made to adapt a particular situation or material to the teachings without departing from the essential scope thereof. Therefore, it is intended that the disclosure not be limited to the particular embodiment disclosed as the best or only mode contemplated for carrying out this disclosure, but that the disclosure will include all embodiments falling within the scope of the appended claims. Also, in the drawings and the description, there have been disclosed exemplary embodiments and, although specific terms can have been employed, they are unless otherwise stated used in a generic and descriptive sense only and not for purposes of limitation.

What is claimed is:

1. A multilayer magnetic film, comprising:
a substrate;
a first magnetic layer disposed on the substrate, wherein the first magnetic layer comprises Fe₍₅₀₋₈₀₎N₍₁₀₋₂₀₎B₍₁₋₂₀)M₍₀₋₁₀₎, wherein M is Si, Ta, Zr, Ti, Co, or a combination thereof; and
a second magnetic layer disposed on the first magnetic layer, wherein the second magnetic layer comprises Fe₍₅₀₋₉₀₎N₍₁₀₋₅₀₎ or Fe₍₆₀₋₉₀₎N₍₁₋₁₀₎Ta₍₅₋₃₀₎;
wherein the multilayer magnetic film has, over a frequency range of 50 MHz to 10 GHz, preferably over a frequency range of 100 MHz to 5 GHz, more preferably over a frequency range of 1 to 5 GHz,
a magnetic permeability of greater than or equal to 1800, preferably greater than or equal to 2000, more preferably greater than or equal to 3000 over a selected frequency band in the frequency range, preferably over a frequency band of 1 to 10 GHz;
a magnetic loss tangent of less than or equal to 0.3, preferably less than or equal to 0.1 over a selected frequency band in the frequency range, preferably over a frequency band of 1 to 10 GHz; and
a cutoff frequency of greater than or equal to 1 GHz, or greater than or equal to 2 GHz, preferably greater than or equal to 5 GHz.

2. The multilayer magnetic film of claim 1, wherein the substrate comprises a glass, polymer, or ceramic, preferably a ceramic.

3. The multilayer magnetic film of claim 1, wherein
the first magnetic layer has a thickness of 10 to 100 nanometers, and
the second magnetic layer has a thickness of 10 to 400 nanometers.

4. The multilayer magnetic film of claim 1, further comprising:
an additional first layer comprising Fe₍₅₀₋₈₀₎N₍₁₀₋₂₀₎B₍₁₋₂₀₎ disposed on the second layer; and
an additional second magnetic layer comprising Fe₍₅₀₋₉₀₎N₍₁₀₋₂₀₎ or Fe₍₆₀₋₉₀₎N₍₁₋₁₀₎Ta₍₅₋₃₀₎ disposed on the additional first magnetic layer.

5. The multilayer magnetic film of claim 4, comprising further additional first and second magnetic layers disposed on the additional second magnetic layer in alternation.

6. The multilayer magnetic film of claim 4, wherein the first magnetic layer and the second magnetic layer have a total thickness of 20 to 500 nanometers.

7. An article comprising the multilayer film of claim 1, preferably wherein the article is a filter, transformer, inductor, antenna, electronic integrated circuit chip, or electromagnetic shielding device.

8. The article of claim 7, wherein the article is a component of an electronic device, preferably a mobile phone, a desktop computer, a laptop computer, a notebook computer, a wireless or LAN network, a power supply, an amplifier, a voltage-controlled oscillator, a shrink power converter, more preferably an integrated electronic device.

9. A method of forming the multilayer magnetic film of claim 1, the method comprising:
depositing the first magnetic layer onto a side of the substrate; and
depositing the second magnetic layer onto a side of the first magnetic layer opposite to the substrate.

10. The method of claim 9, wherein the depositing comprises rf/DC sputtering, electron beam deposition, or a combination thereof.

11. The method of claim 10, further comprising depositing an additional first layer on a side of the second layer opposite the first layer.

12. The method of claim 11, further comprising depositing an additional second layer on a side of the additional first layer opposite the second layer.

13. The method of claim 9, comprising adjusting the thickness of each layer to adjust the magnetic loss tangent of the multilayer magnetic film, the magnetic anisotropy of the magnetic multilayer film, or both.

14. A multilayer magnetic film made by the method of claim 9.
